(19) United States
(12) Patent Application Publication
(10) Pub. No.: US 2006/0191367 A1
(43) Pub. Date: Aug. 31, 2006

(54) Rolling screw device

(75) Inventors: Junji Minakuchi, Maebashi-shi, Gunma (JP); Takayuki Yabe, Gunma (JP)

Correspondence Address: CROWELL & MORING LLP;INTELLECTUAL PROPERTY GROUP, P.O. BOX 14300, WASHINGTON, DC, 20044-4300, US

(73) Assignees: NSK LTD., Shinagawa-ku, Tokyo (JP); NSK Precision Co., Ltd., Shinagawa-ku, Tokyo (JP)

(21) Appl. No.: 10/548,798

(22) PCT Filed: Mar. 12, 2004
(86) PCT No.: PCT/JP04/03298

§ 371 Date: Sep. 12, 2005

(30) Foreign Application Priority Data
Mar. 12, 2003 (JP) 2003-066935

(51) Int. Cl. F16H 25/22

(52) U.S. Cl. 74/424.87

(57) ABSTRACT

A rolling screw device capable of suppressing the rather early occurrence of damage such as cracking on the tongue of an end deflector, wherein the tip part (20a) of the tongue (20) hit by a ball (13) as a rolling element is chamfered in arc shape to increase the contact area of the tip part (20a) of the tongue (20) with the ball (13).

### TECHNICAL FIELD

The present invention concerns a rolling screw device such as a ball screw or a roller screw used, for example, in a feeding device of a machine tool, as a machinery part for converting a rotational movement such as of a motor into a linear movement and, particularly it relates to an internal circulation type rolling screw device.

### BACKGROUND ART

A rolling screw device used, for example, in a feeding device of a machine tool comprises a screw shaft having a spiral internal rolling element raceway groove at the outer circumferential surface thereof, a nut having a spiral external rolling element raceway groove opposed to the internal rolling element raceway groove of the screw shaft at the inner circumferential surface thereof, in which when one of the screw shaft or the nut rotates around the shaft, plural rolling elements assembled in the nut move under rolling motion through a rolling element rolling channel formed between the internal rolling element raceway groove and the external rolling element raceway groove and, along therewith, the nut or the screw shaft conducts a leaner movement.

The rolling screw device described above has a rolling element circulation part for infinite circulation of rolling elements that move under rolling motion through the rolling element rolling channel, and an internal circulation type rolling screw device described in the specification of Utility Model Registration No. 3034052 in Japan uses an end deflector 18 as shown in FIGS. 5A and 5B as a rolling element circulation part. The end deflector 18 has a rolling element guiding channel 19 for guiding the rolling elements that move under rolling motion through the rolling element rolling channel to a rolling element returning through channel formed inside the nut and a tongue 20, in which the rolling elements that move under rolling through the rolling element rolling channel are in contact with the top end of the tongue 20 and introduced to the rolling element guiding channel 19.

However, in the rolling screw device disclosed in the document described above, the top part of the tongue has an edged shape and undergoes the impact load of the rolling element at the edged portion. Accordingly, damage such as cracking for the tongue of the end deflector occurs rather early to sometimes deteriorate the durability of the rolling screw device.

The present invention has been achieved taking notice on the problem described above and intends to provide a rolling screw device capable of suppressing rather early occurrence of damage such as cracking on the tongues of the end deflectors.

### DISCLOSURE OF THE INVENTION

For attaining the forgoing object, the invention provides a rolling screw device comprising a screw shaft having a spiral internal rolling element raceway groove at the outer circumferential surface thereof, a nut having a spiral external rolling element raceway groove opposed to the internal rolling element raceway groove at the inner circumferential surface thereof, a plurality of rolling elements that move under rolling motion along with the rotational movement of the screw shaft or the nut through a rolling element rolling channel between the internal rolling element raceway groove and the external rolling element raceway groove, and end deflectors having a rolling element guiding channel for guiding the rolling elements to a rolling element returning through channel formed inside the nut, in which a tongue for introducing the rolling elements that move under rolling motion through the rolling element rolling channel to the rolling element guiding channel is provided to the end deflectors, wherein the top part of the tongue is chamfered into an arc shape relative to the rolling element.

With the constitution described above, the rolling element in point-to-point contact so far with the top part of the tongue now in face-to-face contact with the top part of the tongue, and the area of contact between the top part of the tongue and the rolling element increases compared with usual case. This enables receiving the impact load of the rolling element on a relatively large area and, since the loaded weight per unit area applied to the top part of the tongue is decreased, it is possible to suppress the rather early occurrence of damage such as cracking on the tongue of the end deflectors. Further, the turn back of the tongue can be prevented when the rolling elements that have moved under rolling motion through the rolling element returning through-channel of the nut leave the rolling element guiding channel of the end deflectors, to improve the life of the end deflector.

The invention further provides a rolling screw device as mentioned above wherein the top part of the tongue is chamfered at a radius of curvature with a ratio relative to the diameter of the rolling element of 0.015 or more. With the adoption of such a construction, it is possible to more effectively suppress the rather early occurrence of damage such as cracking on the tongue of the end deflectors, thereby further improving the durability of the rolling screw device.

### BRIEF DESCRIPTION OF THE DRAWINGS

FIG. 1 is a cross sectional view in the axial direction of a rolling screw device according to an embodiment of the invention.

FIG. 2 is a perspective view showing a portion of a rolling screw device according to the embodiment of the invention.

FIG. 3 is a side elevational view of an end deflector shown in FIG. 2.

FIG. 4 is a graph showing a test result for a ball screw endurance test.

FIGS. 5A and 5B are perspective views of an end deflector used in own rolling screw device.

### DESCRIPTION OF THE DRAWINGS

### Table of Reference Numbers

11 screw shaft
12 nut
13 ball
14 internal rolling element raceway groove
15 external rolling element raceway groove
16 rolling element returning through channel
17 rolling element rolling channel
18 end deflector
19 rolling element guiding channel
20 tongue
20a top part

A preferred embodiment of the present invention is to be described with reference to the drawings.

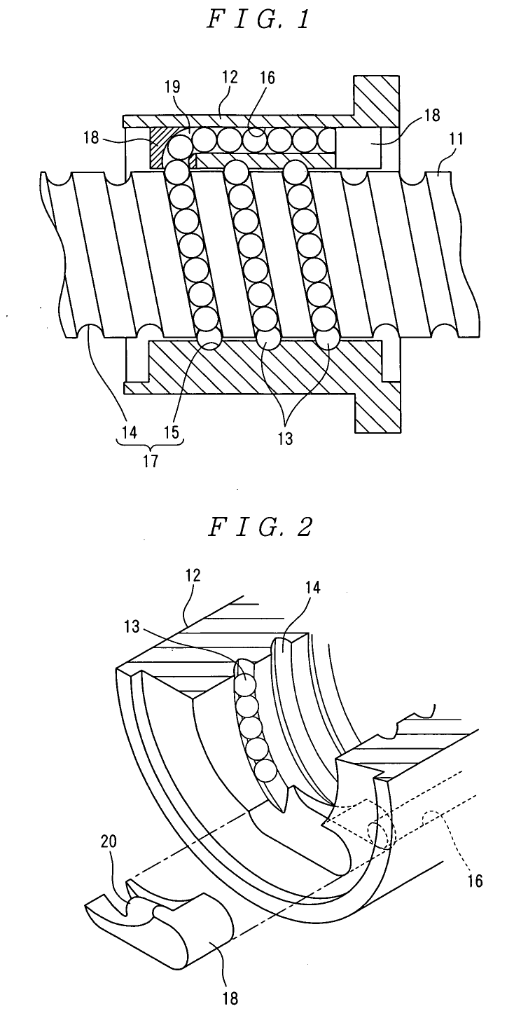

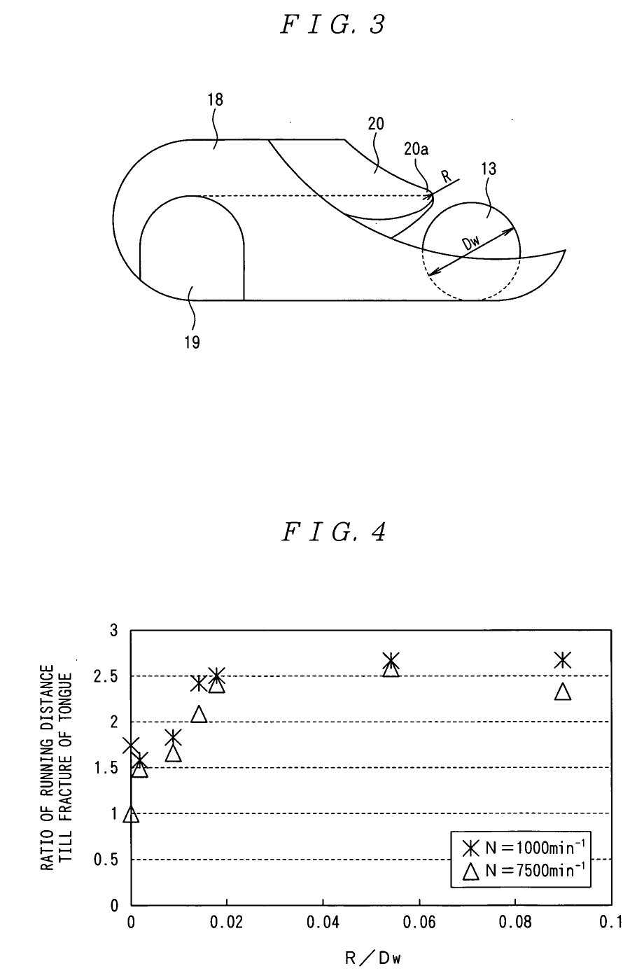

FIG. 1 to FIG. 3 are views showing an embodiment of the invention. As shown in FIG. 1, a rolling screw device according to this embodiment comprises a screw shaft 11, a cylindrical nut 12 relatively moving in the axial direction of the screw shaft 11 and balls 13 as plural rolling elements assembled in the nut 12.

The screw shaft 11 has a transversal plane perpendicular to the axial direction formed as a circular shape, and a spiral internal rolling element raceway groove 14 is formed on the outer circumferential surface of the screw shaft 11 from one end to the other end of the screw shaft 11.

The nut 12 has an inner circumferential surface opposed to the outer circumferential surface of the screw shaft 11, and a spiral external rolling element raceway groove 15 is formed on the inner circumferential surface of the nut 12. Further, the nut 12 is formed relatively thick and a rolling element returning through channel 16 is formed in the nut 12 in the axial direction of the nut 12.

The internal rolling element raceway groove 14 and the external rolling element raceway groove 15 are opposed to each other and, when one of the screw shaft 11 or the nut 12 conducts rotational movement around the shaft, the balls 18 move under rolling motion, correspondingly, through the rolling element rolling channel 17 formed between the internal rolling element raceway groove 14 and the external rolling element raceway groove 15.

A pair of end deflectors 18 for infinite circulation of the balls 13 are attached to both ends of the nut 12. The end deflectors 18 respectively have a rolling element guiding channel 19 (refer to FIG. 1), so that the balls 13 that move under rolling motion through the rolling element rolling channel 17 are introduced through the rolling element guiding channel 19 into the rolling element returning through-channel 16 of the nut 12. Further, the end deflectors 18 are formed, for example, of a resin material by being injection molded into a predetermined shape, and each of the end deflectors 18 is provided with a tongue 20 for introducing the balls 13 that move under rolling motion through the rolling element rolling channel 17 into the rolling element guiding channel 19.

The tongue 20 is formed of a resin material integrally with the end deflector 18. Further, the tongue 20 has a top part 20a for receiving the impact load from the balls 13 that move under rolling motion through the rolling element rolling channel 17, and the top part 20a is chamfered into an arc shape relative to the ball 13 at a radius of curvature R, for example, satisfying the following equation:
R/Dw≧0.015 (1)

in which DW: ball diameter.

As described above, when the top part 20a of the tongue 20 is chamfered into the arc shape relative to the ball 13, the ball 13 which was in point-to-point contact so far with the top part 20a of the tongue 20 is now brought into face-to-face contact with the top part 20a of the tongue 20, so that the area of contact between the top part 20a of the tongue 20 and the ball 13 increases to more than the usual case. Since this enables receiving the impact load of the ball 13 at a relatively large area, and the loaded weight per unit area exerted on the top part 20a of the tongue 20 is decreased, it is possible to suppress the rather early occurrence of damage such as cracking on the tongue 20 of the end deflector 18.

Further, when the top part 20a of the tongue 20 is chamfered into an arc shape relative to the ball 13, turn back of the tongue 20 as the ball 13 that has rotated under rolling motion through the rolling element returning through-channel 16 of the nut 12 leaves the rolling element guiding channels 19 of the end deflectors 18 can be prevented to improve the life of the end deflectors 18.

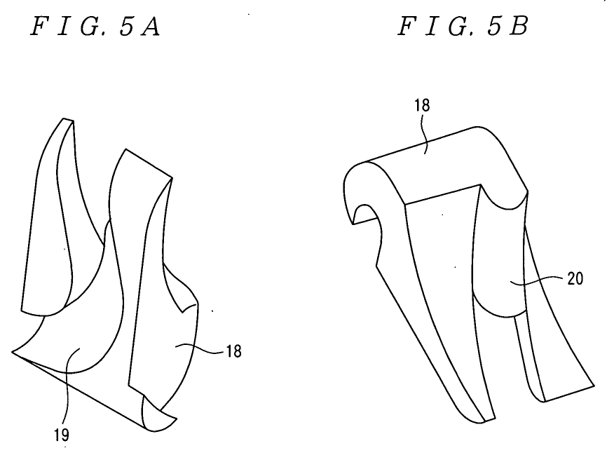

Then, the reason for defining the radius of curvature R for the tongue top part 20a relative to the diameter Dw of the ball 13 as: R/Dw≧0.015 is to be described with reference to Table 1 and FIGS. 5A and 5B.

For examining the relation between the radius of curvature R for the tongue top part 20a and the ball diameter Dw, the present inventors used end deflectors TP 1 to TP 7 of specifications shown in Table 1 as samples and conducted a ball screw endurance test under the test conditions of using ball screws with the name of NSK ball screw (ball screw model number : 40×40×1300), using a tester of ball screw high speed tester manufactured by NSK, at the test rotation speed of 1000 min⁻¹ and 7500 min⁻¹, at a stroke of 1000 mm using lubrication grease of Albania No. 2 (Showa Shell Petroleum). Then, a running distance until damage was observed for the tongues of the end deflectors TP 1 to TP 7 was measured, and the life for each of the end deflectors was evaluated based on the running distance at which damage occurred to the end deflector of the sample No. TP 1 (at rotational speed of 7500 min⁻¹) as a reference. The evaluation results are shown in FIG. 4.

TABLE 1

| Sample No. | R/Dw |
|---|---|
| TP 1 | 0 |
| TP 2 | 0.002 |
| TP 3 | 0.009 |
| TP 4 | 0.015 |
| TP 5 | 0.019 |
| TP 6 | 0.055 |
| TP 7 | 0.09 |

As apparent from FIG. 4, it can be seen that in a case where the ratio between the radius of curvature R for the tongue top part 20a and the ball diameter Dw is made as: R/Dw≧0.015, the ratio of the running distance until the occurrence of damage to the tongue shows a value as high as 2.0 or more, whereas in a case where the ratio between the radius of curvature R for the tongue top part 20a and the ball diameter Dw is made as: R/Dw<0.015, the ratio of the running distance until the occurrence of the damage to the tongue shows a value as low as 2.0 or less.

Accordingly, by chamfering the top part 20a of the tongue 20 at a radius of curvature with the ratio relative to the diameter for the ball 13 of 0.015 or more, it is possible to suppress the rather early occurrence of damage such as cracking on the tongue 20 of the end deflector 18 more effectively.

The present invention is not restricted to the embodiment described above. For example, while the end deflectors are formed of the resin material in the embodiment described above, it is not always necessary to form the end deflectors of a resin material. Further, while the ball is shown as an example of the rolling element in this embodiment, it is not restricted to the ball but it may also be a roller.

As has been described above, in the rolling screw device according to the invention, the rolling element which was so far in point-to-point contact with the top part of the tongue is now brought into face-to-face contact with the top part of the tongue, and the area of contact between the top part of the tongue and the rolling element is increased to more than the usual case. Since this enables receiving the impact load of the rolling element at a relatively large area, and the loaded weight per unit area exerted on the top part of the tongue is decreased, it is possible to suppress the rather early occurrence of damage such as cracking on the tongues of the end deflectors. Further, turn back of the tongue when the rolling element that has moved under rolling motion through the rolling element returning through-channel of the nut leaves the rolling element guiding channels of the end deflectors can be prevented to improve the life of the end deflectors.

According to the rolling screw device of the invention, it is possible to suppress the rather early occurrence of damage such as cracking on the tongues of the end deflectors more effectively.

1-2. (canceled)

3. A rolling screw device, comprising:
a screw shaft having a spiral internal rolling element raceway groove at an outer circumferential surface thereof;
a nut having a spiral external rolling element raceway groove opposed to the internal rolling element raceway groove at an inner circumferential surface thereof,
a plurality of rolling elements that move under rolling motion along with the rotational movement of the screw shaft or the nut through a rolling element rolling channel formed between the internal rolling element raceway groove and the external rolling element raceway groove; and
end deflectors having a rolling element guiding channel for guiding the rolling elements to a rolling element returning through-channel formed inside the nut, in which a tongue is provided for introducing the rolling elements that move under rolling motion through the rolling element rolling channel to the rolling element guiding channel;
wherein a top part of the tongue is chamfered into an arc shape relative to the rolling element.

4. The screw device according to claim 3, wherein the top part of the tongue is chamfered at a radius of curvature with a ratio relative to a diameter of the rolling element of 0.015 or more.
